(19) United States
(12) Patent Application Publication
(10) Pub. No.: US 2013/0149434 A1
(43) Pub. Date: Jun. 13, 2013

(54) METHOD OF CUTTING TEMPERED GLASS AND METHOD OF FABRICATING TOUCHSCREEN USING THE SAME

(71) Applicant: Samsung Corning Precision Materials Co., Ltd., Gyeongsangbuk-do (KR)

(72) Inventors: Sang Yoon Oh, ChungCheongNam-Do (KR); Ji Yoon Seo, ChungCheongNam-Do (KR); Jin Soo An, ChungCheongNam-Do (KR); Jin Sung Lim, ChungCheongNam-Do (KR)

(73) Assignee: SAMSUNG CORNING PRECISION MATERIALS CO., LTD., Gyeongsangbuk-do (KR)

(21) Appl. No.: 13/708,366

(22) Filed: Dec. 7, 2012

(30) Foreign Application Priority Data
Dec. 9, 2011 (KR) 10-2011-0131741

(51) Int. Cl. C03B 33/07

(52) U.S. Cl. CPC C03B 33/074
USPC 427/58; 427/289

(57) ABSTRACT

A method of cutting a piece of tempered glass in which the piece of tempered glass is cut after a thin film having a tensile stress is formed a method of fabricating a touchscreen using the same. The method includes a step of forming a thin film layer having a tensile stress on the piece of tempered glass and a step of cutting the piece of tempered glass.

### CROSS REFERENCE TO RELATED APPLICATION

The present application claims priority from Korean Patent Application Number 10-2011-0131741 filed on Dec. 9, 2011, the entire contents of which application are incorporated herein for all purposes by this reference.

### BACKGROUND OF THE INVENTION

1. Field of the Invention

The present invention relates to a method of cutting a piece of tempered glass and a method of fabricating a touchscreen using the same, and more particularly, a method of cutting a piece of tempered glass in which the piece of tempered glass is cut after a thin film having a tensile stress is formed a method of fabricating a touchscreen using the same.

2. Description of Related Art

Glass products are regarded as key components in a number of technological and industrial fields including imaging and optical equipment, such as monitors, cameras, video tape recorders (VTRs) and mobile phones, transportation equipment, such as vehicles, types of tableware, construction facilities, and the like. Different types of glass having various properties based on the characteristics of the respective industrial fields are being manufactured and used.

Among them, imaging equipment that uses a touchscreen is gaining interest as a key component. The touchscreen is a display and input device that is installed in a monitor for a terminal. The touchscreen can detect an auxiliary input means, such as a finger or stylus, which simply touches it or writes letters or draws a figure thereon, and sends the detection as input data to a computer, thereby causing the computer to follow a specific command. As a key component of a variety of digital devices which transfers information in one direction or exchanges information in bidirectional communication, including a mobile communication device such as a smartphone, a computer, a camera, a dispenser for a certificate or the like, industrial equipment, or the like, the importance of the touchscreen is increasing and the range of the use of the touchscreen is rapidly expanding.

Among components of the touchscreen, an upper transparent protective layer which a user directly touches is generally made of a plastic organic material such as polyester, acryl, or the like. These materials have the problem of limited endurance. That is, they have weak thermal resistance and mechanical strength, and are vulnerable to deformation, scratches or other types of damage due to continuous and repeated use and contacts. Therefore, a material for the upper transparent protective layer of the touchscreen is gradually changing from the existing plastic materials to thin chemically tempered glass which has superior thermal resistance, mechanical strength and hardness. In addition to the use for the touchscreen, the thin chemically tempered glass is used for a transparent protective window of a liquid crystal display (LCD) or organic light-emitting diode (OLED) monitor. Therefore, the range in which the thin chemically tempered glass is used is gradually expanding.

Glass is tempered by a physical tempering method so-called air-cooling tempering which is generally applied to safety glass for vehicles and a chemical tempering method. In particular, the chemical tempering method can be applied to thin sheets of glass having a more complicated shape or a thickness of about 2 mm or less. The chemical tempering method is a technology of exchanging alkali ions having a small ion radius (generally Na ions) which are present inside the glass with alkali ions having a greater ion radius (generally K ions). According to this method, strong compressive stress is created in the surface of the glass due to ion exchange, thereby increasing the strength and hardness of the glass.

In the meantime, the chemically tempered glass has a problem in that it is difficult to cut it into a desired size or shape once it is tempered. Specifically, the tempered glass is fractured into fragments having irregular shapes rather than being fractured into the desired shape, attributable to the strong compressive stress present in the surface thereof. Even if the tempered glass is cut into a given shape, the strength of the tempered glass decreases since the compressive stress over a wide area spanning about 20 mm to the left and right from the cut line is canceled.

Accordingly, in the related art, a piece of glass is cut into a predetermined size or shape as required, followed by chemical tempering. This however leads to the drawback of the low productivity of tempered glass products.

In addition, although there is a method of chemically tempering glass to a low strength that is about half of that achieved in the existing chemical tempering, this consequently compensates the strength of the tempered glass, which is problematic.

The information disclosed in the Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a method of cutting a piece of tempered glass and a method of fabricating a touchscreen using the same where productivity is increased without losses in the strength of a piece of tempered glass.

In an aspect of the present invention, provided is a method of cutting a piece of tempered glass. The method includes the steps of: forming a thin film layer having a tensile stress on the piece of tempered glass; and cutting the piece of tempered glass.

In an exemplary embodiment, the method may further include the step of removing the thin film layer after the step of cutting the piece of tempered glass.

In an exemplary embodiment, the thin film layer may be made of indium tin oxide (ITO) or aluminum zinc oxide (AZO).

In an exemplary embodiment, the thickness of the thin film layer may range from 10 nm to 500 nm.

In an exemplary embodiment, the piece of tempered glass may be a piece of chemically tempered glass.

In another aspect of the present invention, provided is a method of fabricating a touchscreen panel. The method includes the steps of: forming a thin film layer having a tensile stress on one surface of a piece of tempered glass and disposing a plurality of touch sensors on the other surface of the piece of tempered glass; cutting the piece of tempered glass; and removing the thin film layer.

In an exemplary embodiment, the thin film layer may be made of indium tin oxide (ITO) or aluminum zinc oxide (AZO).

In an exemplary embodiment, the method may further include, before disposing the plurality of touch sensors, the step of forming periphery portions on the other surface of the piece of tempered glass on which the plurality of touch sensors are to be disposed, such that the periphery portions correspond to outer peripheries of the plurality of touch sensors

In an exemplary embodiment, the method may further include, after the step of cutting the piece of tempered glass, the step of chamfering edges of the cut piece of tempered glass.

According to embodiments of the present invention, it is possible to cut a piece of tempered glass into a desired size or shape while maintaining the strength of the piece of tempered glass.

In addition, a piece of tempered glass can be manufactured at a rapid rate, thereby improving the productivity of tempered glass products.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a schematic flowchart showing a method of cutting a piece of tempered glass according to an embodiment of the present invention; and

FIG. 2 is a schematic flowchart showing a method of fabricating a touchscreen panel according to another embodiment of the present invention.

### DETAILED DESCRIPTION OF THE INVENTION

Reference will now be made in detail to each embodiment of a method of cutting piece of tempered glass and a method of fabricating a touchscreen using the same according to the present invention with reference to the accompanying drawings.

In the following description of the present invention, detailed descriptions of known functions and components incorporated herein will be omitted when they may make the subject matter of the present invention unclear.

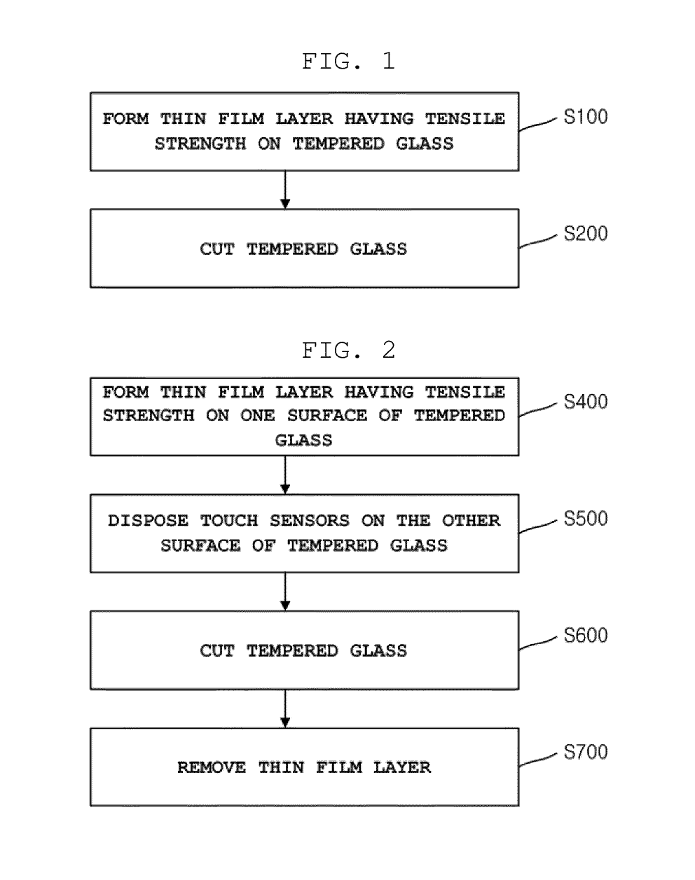

FIG. 1 is a schematic flowchart showing a method of cutting a piece of tempered glass according to an embodiment of the present invention.

Referring to FIG. 1, the method of cutting a piece of tempered glass according to this embodiment includes a step of forming a thin film and a cutting step.

In the method of cutting a piece of tempered glass, at S100, first, a thin film having a tensile stress is formed on one surface of a piece of tempered glass.

The piece of tempered glass can be a piece of chemically tempered glass. However, the present invention is not limited to the chemically tempered glass.

The piece of tempered glass has a compressive stress which is formed by tempering in the surface layer thereof.

Therefore, it is possible to control the surface strain of the piece of tempered glass by forming the thin film layer having a tensile stress.

Specifically, the thin film having a tensile stress is formed on the surface of the piece of tempered glass having a compressive stress so as to destroy or reduce the compressive strain in the surface of the piece of tempered glass, thereby decreasing the strength of the tempered glass.

In general, glass has a coefficient of thermal expansion ranging from 3.7×10⁻⁶/K to 8.0×10⁻⁶/K. Therefore, it is possible to destroy or reduce the compressive stress in the surface of the glass when the surface of the glass is coated with the thin film having a greater coefficient of thermal expansion than the glass.

Here, the thin film layer can be made of indium tin oxide (ITO) having a coefficient of thermal expansion from about 8.5×10⁻⁶/K to about 10.2×10⁻⁶/K or aluminum zinc oxide (AZO) having a coefficient of thermal expansion from about 3.7×10⁻⁶/K to about 8.0×10⁻⁶/K.

In addition, the thin film layer may have a thickness ranging from 10 nm to 500 nm.

The increasing thickness of the thin film layer can lead to an increase in tensile stress, which is advantageous for the cutting of glass. However, the thickness of the thin film layer will be determined regarding a rate at which the thin film is deposited, a rate at which the thin film is manufactured, a rate at which the glass is etched after being cut, or the like.

The thin film layer can be formed by a variety of methods such as sputtering, chemical vapor deposition (CVD), or the like.

Afterwards, at S200, the piece of tempered glass is cut by a predetermined size by a variety of means such as a laser, a diamond wheel, or the like.

In this way, the glass can be cut into a predetermined size or shape after being strengthened rather than being strengthened after being cut. This can consequently increase the rate at which tempered glass products are manufactured and improve the productivity of tempered glass products.

In addition, the method of cutting a piece of tempered glass according to this embodiment may also include an etching step of removing the thin film layer which is formed on the piece of tempered glass.

When the thin film layer formed on the piece of tempered glass is removed by etching after the piece of tempered glass is cut, it is possible to restore the strength of the piece of tempered glass into the original value.

FIG. 2 is a schematic flowchart showing a method of fabricating a touchscreen panel according to another embodiment of the present invention.

The touchscreen panel is a device that can detect a finger or stylus pressing it and send the pressing as input information to an information processing device such as a computer. The touchscreen panel can be classified into several types, such as a resistive film type, a capacitance type, an infrared (IR) type, or the like.

Referring to FIG. 2, the method of fabricating a touchscreen panel according to this embodiment includes a step of forming a thin film layer, a step of depositing touch sensors, a cutting step and an etching step.

In the method of fabricating a touchscreen panel, at 400, first, a thin film layer having a tensile stress is formed on one surface of a piece of tempered glass.

Here, the thin film layer having a tensile stress can be made of indium tin oxide (ITO) or aluminum zinc oxide (AZO).

As described above in the former embodiment, when the tempered glass is coated with a thin film layer having a tensile stress, the strength of the piece of tempered glass can be weakened.

Afterwards, at S500, a plurality of touch sensors is disposed on the other surface of the piece of tempered glass.

Describing the disposition of the touch sensors in the case of, for example, a capacitance type touchscreen panel, first, a substrate made of glass or a polyethylene terephthalate (PET) film is coated with a transparent conductive film. The transparent conductive film is formed by sputtering or depositing indium tin oxide (ITO), indium zinc oxide (IZO), zinc oxide (ZnO), cadmium zinc oxide (CZO), or the like on the substrate. Afterwards, a transparent electrode pattern is formed by removing part of the coated transparent conductive film. The transparent electrode pattern can be formed by photolithography, laser processing, or the like. After that, conductive circuit lines are formed such that they are electrically connected to the transparent electrode pattern. The conductive circuit lines are formed by applying conductive ink by silk screen printing. Finally, the touch sensors are disposed on the other surface of the piece of tempered glass by bonding and coupling the touch sensors to the piece of tempered glass.

In sequence, at S600, the piece of tempered glass on which the touch sensors are disposed is cut into a designed size, and at S700, the thin film layer is removed. In this way, the touchscreen panel can be fabricated.

In this way, the touchscreen panel can be fabricated by cutting the large piece of tempered glass after disposing the plurality of touch sensors thereon, thereby making it possible to increase the productivity of the touchscreen panel while maintaining the strength of the tempered glass.

In addition, the method of fabricating a touchscreen panel of the present invention can also include a step of forming periphery portions on the surface of the tempered glass on which the touch sensors are to be disposed, the periphery portions of the tempered glass corresponding to outer peripheries of touch sensors, before the step of disposing the plurality of touch sensors.

The periphery portions prevent light that is emitted from a backlight unit which illuminates the touchscreen panel from exiting so that internal components are not viewed from the outside, and increase the contrast of an effective screen due to the difference in light between the periphery portions and the effective screen. The periphery portions also provide a generous aesthetic sense, thereby improving the visual quality of the touchscreen panel.

Furthermore, the method of fabricating a touchscreen panel of the present invention can also include, after the cutting step, a step of chamfering edges of the piece of glass which were sharpened by the cutting.

The foregoing descriptions of specific exemplary embodiments of the present invention have been presented with respect to the certain embodiments and drawings. They are not intended to be exhaustive or to limit the invention to the precise forms disclosed, and obviously many modifications and variations are possible for a person having ordinary skill in the art in light of the above teachings.

It is intended therefore that the scope of the invention not be limited to the foregoing embodiments, but be defined by the Claims appended hereto and their equivalents.

What is claimed is:

1. A method of cutting a piece of tempered glass, comprising:
forming a thin film layer having a tensile stress on the piece of tempered glass; and
cutting the piece of tempered glass.

2. The method of claim 1, further comprising removing the thin film layer after cutting the piece of tempered glass.

3. The method of claim 2, wherein removing the thin film layer after cutting the piece of tempered glass comprises etching the thin film layer.

4. The method of claim 1, wherein the piece of tempered glass is a piece of chemically tempered glass.

5. The method of claim 1, wherein the thin film layer has a greater coefficient of thermal expansion than the piece of tempered glass.

6. The method of claim 1, wherein forming the thin film layer comprises depositing the thin film layer.

7. The method of claim 1, wherein the thin film layer comprises indium tin oxide or aluminum zinc oxide.

8. The method of claim 1, wherein a thickness of the thin film layer ranges from 10 nm to 500 nm.

9. A method of fabricating a touchscreen panel, comprising:
forming a thin film layer having a tensile stress on one surface of a piece of tempered glass and disposing a plurality of touch sensors on the other surface of the piece of tempered glass;
cutting the piece of tempered glass; and
removing the thin film layer.

10. The method of claim 9, wherein removing the thin film layer after cutting the piece of tempered glass comprises etching the thin film layer.

11. The method of claim 9, wherein the thin film layer comprises indium tin oxide or aluminum zinc oxide.

12. The method of claim 9, further comprising, before disposing the plurality of touch sensors, forming periphery portions on the other surface of the piece of tempered glass on which the plurality of touch sensors are to be disposed, such that the periphery portions correspond to outer peripheries of the plurality of touch sensors.

13. The method of claim 9, further comprising, after cutting the piece of tempered glass, chamfering edges of the cut piece of tempered glass.
